(19) United States
(12) Patent Application Publication
(10) Pub. No.: US 2021/0138700 A1
(43) Pub. Date: May 13, 2021

(54) DOOR PANEL MANUFACTURING PROCESS

(71) Applicant: EVERTRADE VIETNAM CO., LTD., New Taipei City (TW)

(72) Inventor: Juan-Ching CHOU, Bien Hoa City (VN)

(73) Assignee: EVERTRADE VIETNAM CO., LTD.

(21) Appl. No.: 16/682,165

(22) Filed: Nov. 13, 2019

(51) Int. Cl. B29C 44/12; B29C 33/58; B29C 41/08; B29C 44/56

(52) U.S. Cl. CPC B29C 44/12; B29C 33/58; B29L 2031/724; B29C 44/56; B29C 41/08

(57) ABSTRACT

A door panel manufacturing process is provided by constructing a high load conveyor line capable of controlling speed and duration, subsequently placing a finished door panel mold on the high load conveyor line. The conveyor line can be used to control a shifting speed and duration, and a de-molding agent can be sprayed inside the door panel mold, followed by spraying a high-density foam resin to form a shell. The door panel mold further has a framework or a reinforcement member mounted therein, and a low-density foam resin is injected; after the foam resin is formed and cooled, the door panel made of foam resin is completed. The process solve issues of high defective rate and insufficient surface strength associated with the conventional foam door panel, and is capable of significantly reducing the electricity required as well as reducing logging of woods, thereby realizing environmental protection.

### BACKGROUND OF THE INVENTION

### a) Field of the Invention

The present invention relates to a door panel manufacturing process and, more particularly, to a door panel manufacturing process that achieves quick and simple manufacturing, and is capable of lowering production costs and increasing production yield rate of door panels.

### b) Description of the Prior Art

A door panel is a building material absolutely required in general buildings; based on materials, the types of door panel can be distinguished into many varieties, with wooden door panels, plastic door panels and metal door panels being the most common ones. Of these, production costs of wooden door panels are rising steadily given that timber materials are becoming scarce due to an increased demand for protection of the rainforest environment. In addition, wooden door panels are also prone to decomposition under the effect of humidity, which further leads to issues such as infestation by termites and ants, as well as becoming unsturdy.

Metal door panels are susceptible to oxidation and have issues like being difficult to work with and to install due to their heavier weight; if an installation area is more humid, the door panels become rusty easily and are therefore hard to maintain.

As for plastic door panels, they are used more prevalently by consumers due to advantages including being damp-proof, not prone to oxidation and is durable to use.

Although plastic door panels have many advantages, they are mostly made by having each part and component completed first, and then finishing the whole door by assembling the same, which is complicated to make and time-consuming to assemble, thus making the manufacturing process uneconomical.

In addition, plastic door panels are mostly hollow inside, which causes the overall structural strength to be weak, and a large amount of electricity is required in a manufacturing process of plastic door panels, leading to the problem of not being environmentally friendly under the current context of a global promotion for environmental protection.

In particular, plastic door panels generally have a large size, and a large amount of electricity is required in order to enable plastics to reach a flowable state, causing even more electricity to be consumed in this process.

Accordingly, the manufacturing method for a conventional door panel is disadvantageous and not well designed, thus requiring further improvements.

In light of the various disadvantages resulted from the manufacturing method of the described conventional door panels, the inventor of the present application has been trying to improve on the method, and has successfully developed and completed the door panel manufacturing process of the present application after strenuous researches.

### SUMMARY OF THE INVENTION

An object of the present invention is to provide a door panel manufactured by injecting a low-density foam resin into a door panel mold, such that a large amount of electricity required for making a conventional plastic door panel can be significantly reduced; in addition, the high defective rate in making a conventional door panel can also be lowered. To achieve the aforesaid object, the door panel manufacturing process of the present invention comprises the following steps:

(A) firstly constructing a high load conveyor line capable of controlling speed and duration;

(B) making a door panel mold capable of being shifted on the conveyor line, wherein the door panel mold at least comprises an upper mold and a lower mold, and the upper mold and the lower mold form an accommodation space therebetween;

(C) spraying a de-molding agent and then a high-density resin on an inner surface of the door panel mold, so as to form a door panel shell;

(D) mounting a reinforcement member in the accommodation space of the door panel mold, wherein the reinforcement member is provided to reinforce a structural strength of a door panel;

(E) injecting a low-density foam resin into the accommodation space of the door panel mold; and

(F) after foam forming and cooling, de-molding and removing to obtain a finished door panel product.

The present invention at least has the following advantages:

1. The door panel manufacturing process of the present invention ensures a stable manufacturing condition by controlling speed of the conveyor line and accurately handling a chemical reaction time of each part. The manufactured door panel is reliable and robust, thus solving the issues of high defective rate and insufficient surface strength associated with conventional foam door panels.

2. The door panel manufacturing process of the present invention is capable of significantly reducing the electricity required for the process, thus realizing environmental protection.

Detailed explanations and drawings of the present invention are provided to facilitate better understanding about characteristics and technical contents of the present invention. However, the drawings are only meant for providing references and explanations, and are not to be used to limit the present invention.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a schematic view of a flow chart showing a door panel manufacturing process according to the present invention.

FIG. 2 is a three-dimensional schematic view showing the door panel manufacturing process according to the present invention.

FIG. 3 is a structural schematic view showing a door panel mold of the door panel manufacturing process according to the present invention.

FIG. 4 is a schematic view showing a reinforcement member mounted in the door panel mold of the door panel manufacturing process according to the present invention.

FIG. 5 is a schematic view showing foam forming of a door panel in the door panel manufacturing process according to the present invention.

### DETAILED DESCRIPTION OF THE PREFERRED EMBODIMENTS

Preferred embodiments and corresponding drawings are provided along with detailed explanations below, in order to promote better understanding about the described and other purposes, characteristics and advantages of the present invention.

Referring to FIGS. 1 to 5, the present invention provides a door panel manufacturing process having the following manufacturing process:

(A) 10: firstly constructing a high load conveyor line 24 capable of controlling speed and duration;

(B) 11: making a door panel mold 2 for being provided on the high load conveyor line 24, the conveyor line 24 being capable of controlling shifting, wherein the door panel mold 2 at least comprises an upper mold 21 and a lower mold 22, and the upper mold 21 and the lower mold 22 form an accommodation space 23 therebetween, to enable a door panel to have patterns, inner surfaces of the upper mold 21 and the lower mold 22 can have door panel patterns fabricated thereon by means of etching or engraving, and it should be particularly noted that a fabrication manner of the door panel patterns is not limited to said method;

(C) 12: spraying a de-molding agent and then a high-density resin on an inner surface of the door panel mold 2, so as to form a door panel shell, wherein the high-density resin can have a color paste mixed therein so as to make door panels having different colors;

(D) 13: shifting the door panel mold 2 to a second position, mounting a reinforcement member 3 in the accommodation space 23 of the door panel mold 2, wherein the reinforcement member 3 is provided to reinforce a structural strength of a door panel, and the reinforcement member 3 can be made of a metal material or a tough material;

(E) 14: shifting the door panel mold 2 to a third position, injecting a low-density foam resin 4 into the accommodation space 23 of the door panel mold 2; and

(F) 15: shifting the door panel mold 2 to a fourth position, after foam forming and cooling, de-molding and removing to obtain a finished door panel product.

From the described manufacturing process, it can be seen that the door panel manufacturing method of the present invention can be used to solve issues of high defective rate and insufficient surface strength associated with a conventional plastic door panel, as well as significantly reducing the electricity required for manufacturing a plastic door panel.

In addition, the high load conveyor line 24 is used for mounting the door panel mold 2 and is capable of controlling a moving speed of the door panel mold 2, so as to realize accurately handling a chemical reaction time of each step of the process and stabilize a production condition. In the present embodiment, the conveyor line 24 is a track, and the door panel mold 2 is shifted and actuated on a trolley 25 on the track.

The present invention is characterized in that:

1. The electricity required for running the door panel manufacturing process of the present invention is limited to only powering the conveyor line and a foaming machine or a spraying machine; therefore, the consumed electricity is very small and meets the purpose of energy saving and environmental protection.

2. The door panel manufacturing process of the present invention overcomes the issues of an excessively high defective rate and a requirement of a large amount of manual labor for finishing, and enhances surface strength and weatherproofness by spraying a high-density resin to manufacture a shell.

The given detailed explanations are specific explanations with respect to a feasible embodiment of the present invention, it is to be understood that the embodiment is not to be used to limit the scope of the present invention. Any equivalent implementations or modifications thereto without departing from the spirit of the present invention should be included within the scope of the present application. The claimed scope of the present invention is set forth in the following claims.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A door panel manufacturing process, comprising the following steps:
(A) constructing a high load conveyor line capable of controlling speed and duration;
(B) making a door panel mold capable of being shifted and actuated on the conveyor line, wherein the door panel mold at least including an upper mold and a lower mold, and the upper mold and the lower mold thereby forming an accommodation space therebetween;
(C) spraying a de-molding agent and then a high-density resin on an inner surface of the door panel mold, so as to form a door panel shell;
(D) shifting the door panel mold to a second position, mounting a reinforcement member in the accommodation space of the door panel mold, wherein the reinforcement member is provided to reinforce a structural strength of a door panel;
(E) shifting the door panel mold to a third position, injecting a low-density foam resin into the accommodation space of the door panel mold; and
(F) shifting the door panel mold to a fourth position, after foam forming and cooling, de-molding and removing to obtain a finished door panel product.

2. The door panel manufacturing process of claim 1, wherein the upper mold and the lower mold of the door panel mold having door panel patterns fabricated on inner surfaces thereof by means of etching or engraving.

3. The door panel manufacturing process of claim 1, wherein the high-density resin having a color paste mixed therein such that the door panels are made with different colors.

4. The door panel manufacturing process of claim 1, wherein the conveyor line is a track and a trolley is provided on the track.

5. The door panel manufacturing process of claim 1, wherein the door panel mold is provided on the trolley of the track.
